(19) United States
(12) Patent Application Publication
(10) Pub. No.: US 2025/0309407 A1
(43) Pub. Date: Oct. 2, 2025

(54) BOX, CELL LIQUID COOLING BOX AND BATTERY PACK

(71) Applicant: Eve Energy Storage Co., Ltd., Wuhan (CN)

(72) Inventors: Weikang XIE, Wuhan (CN); Shilin FAN, Wuhan (CN); Chaojun FENG, Wuhan (CN); Guotao LI, Wuhan (CN); Donglei JIANG, Wuhan (CN); Meisa ZHOU, Wuhan (CN); Muhong GONG, Wuhan (CN)

(73) Assignee: Eve Energy Storage Co., Ltd., Wuhan (CN)

(21) Appl. No.: 19/051,271

(22) Filed: Feb. 12, 2025

(30) Foreign Application Priority Data
Mar. 31, 2024 (CN) 202420649430.5
Mar. 31, 2024 (CN) 202420650071.5
Jun. 18, 2024 (WO) PCT/CN2024/099772

(51) Int. Cl. H01M 10/6568; H01M 10/613; H01M 50/271; H01M 50/291; H01M 50/342

(52) U.S. Cl. CPC H01M 10/6568; H01M 10/613; H01M 50/271; H01M 50/291; H01M 50/3425; H01M 2200/20

(57) ABSTRACT

The present disclosure provides a box, a cell liquid cooling box and a battery pack, the box includes a box body including a first end plate and a second end plate arranged opposite to each other, a liquid inlet and a liquid outlet are provided on the first end plate; and a separator provided inside the box body to divide the interior of the box body into multiple cell installation chambers, a first flow channel is provided inside the separator, the end of the first flow channel away from the first end plate is provided with a plurality of first outflow outlets, one of the first outflow outlets is connected to and communicated with one of the cell installation chambers, and each of the cell installation chambers is connected to the liquid outlet.

### CROSS-REFERENCE TO RELATED APPLICATION

This application claims priority to and the benefit of priority of Chinese Patent Application No. 202420650071.5 and No. 202420649430.5, both filed on Mar. 31, 2024, and International Application No. PCT/CN2024/099772, filed on Jun. 18, 2024, the disclosures of which are incorporated herein by reference in their entireties.

### TECHNICAL FIELD

The present application relates to the field of battery technology, and in particular to a box, cell liquid cooling box and battery pack.

### BACKGROUND

In the field of batteries, traditional heat dissipation methods generally include the following methods: natural cooling, air cooling, phase change cooling, or bottom liquid-cooled plate cooling, etc. These methods are usually not enough to solve the rapid temperature rise caused by high power discharge of cells in the battery pack, which are difficult to ensure the balance of temperature difference between the cells.

Traditional heat dissipation methods do not effectively solve a problem of dissipating the rapid temperature rise caused by high power discharge of cells in the battery pack, which affects the temperature difference balance between the cells.

### SUMMARY

In a first aspect, the present disclosure provides a box including:

a box body including a first end plate and a second end plate arranged opposite to each other, in which the first end plate is provided with a liquid inlet and a liquid outlet;

a separator disposed inside the box body, both ends of the separator are connected to the first end plate and the second end plate, respectively, the interior of the box body is divided into a plurality of cell installation chambers, a first flow channel is provided within the separator, one end of the first flow channel is connected to the liquid inlet, and another end of the first flow channel extends toward the second end plate and is provided with a plurality of first outflow outlets connected to the cell installation chambers, and the cell installation chambers are also connected to the liquid outlet.

In a second aspect, the present disclosure further provides a cell liquid cooling box including the box body as described in the first aspect and a box cover, and the box is covered by the box cover.

In a third aspect, the present disclosure further provides a battery pack including the cell liquid cooling box as described in the second aspect and a plurality of battery units, and the battery units are installed inside cell installation chambers.

### BRIEF DESCRIPTION OF THE DRAWINGS

FIG. 1 is a structural diagram of a cell liquid cooling box provided by some embodiments of the present disclosure.

FIG. 2 is an exploded structural diagram of the cell liquid cooling box provided by some embodiments of the present disclosure.

FIG. 3 is a cross-sectional structural view of the cell liquid cooling box along line A-A in FIG. 2.

FIG. 4 is a structural diagram of a box cover in the cell liquid cooling box provided by some embodiments of the present disclosure.

FIG. 5 is a schematic cross-sectional view of the box cover of the cell liquid cooling box provided by some embodiments of the present disclosure.

FIG. 6 is another schematic cross-sectional view of the box cover of the cell liquid cooling box provided by some embodiments of the present disclosure.

FIG. 7 is a structural diagram of a battery pack provided by some embodiments of the present disclosure.

FIG. 8 is an exploded schematic diagram of the battery pack provided by some embodiments of the present disclosure.

FIG. 9 is a schematic cross-sectional view of the battery pack provided by some embodiments of the present disclosure.

FIG. 10 is a schematic cross-sectional view of the battery pack provided by some embodiments of the present disclosure.

FIG. 11 is another schematic cross-sectional view of the battery pack provided by some embodiments of the present disclosure.

### EXPLANATION OF REFERENCE NUMERALS

1. box body; 11. liquid inlet; 12. liquid outlet; 13. box cover; 14. second flow channel; 15. third flow channel; 16. first end plate; 17. second end plate; 18. first side plate; 19. second side plate; 20. bottom plate; 2. separator; 21. first flow channel; 22. first outflow outlet; 23. fourth flow channel; 24. second outflow outlet; 3. cell installation chamber; 4. abutting plate; 5. battery unit; 51. cell; 511. explosion-proof valve; 52. fifth flow channel; 6. mounting case; 61. first accommodating chamber; 62. second accommodating chamber; 63. third accommodating chamber; 7. case cover; 8. cover body; 81. discharge channel; 82. protruding portion; 83. mounting hole; 84. threaded hole; 85. extending portion; 9. pressure relief valve; 10. discharge port.

### DETAILED DESCRIPTION

In the description of this disclosure, unless otherwise expressly specified or limited, the terms “connected”, “coupled” and “fixed” should be understood in a broad sense. For example, these terms can refer to fixed connection, detachable connection, or integral formation; mechanical connection or electrical connection; direct connection, indirect connection through intermediate media, or internal communicating connection between two components or an interaction relationship between two components. For those skilled in the art, the specific meanings of these terms in this disclosure can be understood based on the specific situations.

In this disclosure, unless otherwise expressly specified or limited, the expression “the first feature is above or below the second feature” may include direct contact between the first feature and the second feature, or may include contact between the first feature and the second feature through another feature between them instead of direct contact. Additionally, the expression “the first feature is over, above, and on top of the second feature” includes “the first feature is directly above or diagonally above the second feature” and “the horizontal height of the first feature is higher than that of the second feature”. The expression “the first feature is under, below, and beneath the second feature” includes “the first feature is directly below or diagonally below the second feature” and “the horizontal height of the first feature is lower than that of the second feature”.

In the description of this disclosure, the terms such as “up”, “down”, “left”, “right”, “front”, “back”, and etc. that indicate directional or positional relationships are based on the directional or positional relationships shown in the drawings. These terms are used for the convenience of description and simplification of operations, and are not intended to indicate or imply that the device or element must have a specific direction or be constructed and operated in a particular direction. Therefore, they should not be understood as a limitation on this disclosure. Additionally, the terms “first” and “second” are used to distinguish in terms of description and do not have a specific meaning.

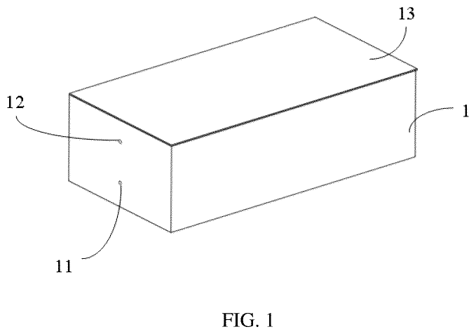

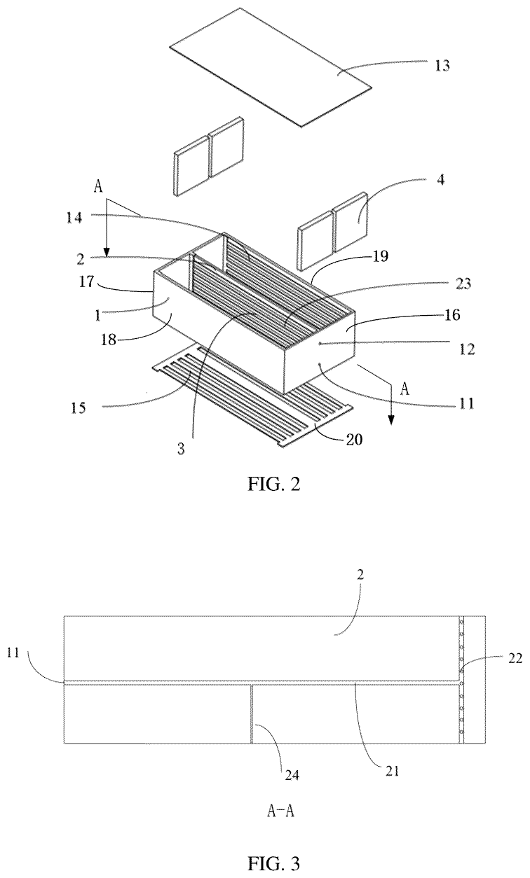

Referring to FIG. 1 and FIG. 2, FIG. 1 is a structural diagram of a cell liquid cooling box provided in an embodiment of the present disclosure, FIG. 2 is an exploded schematic diagram of the cell liquid cooling box provided in an embodiment of the present disclosure. The present disclosure provides a cell liquid cooling box, including a box and a box cover 13, the box cover 13 is covered on the box.

FIG. 3 is a cross-sectional structural diagram of a separator 2 of the box in FIG. 2 along the A-A section provided in the embodiment of the present disclosure. The present disclosure provides a box, including:
a box body 1, including a first end plate 16 and a second end plate 17 arranged opposite to each other, a liquid inlet 11 and a liquid outlet 12 are both provided on the first end plate 16;
a separator 2 disposed inside the box body 1, both ends of the separator 2 are connected to the first end plate 16 and the second end plate 17, respectively. The interior of the box body 1 is divided into a plurality of cell installation chambers 3, and a first flow channel 21 is provided within the separator 2, one end of the first flow channel 21 is connected to the liquid inlet 11 and the other end of the first flow channel 21 extends to the second end plate 17 and is provided with a plurality of first outflow outlets 22, the first outflow outlets 22 are connected to the cell installation chambers 3, and each of the cell installation chambers 3 is connected to the liquid outlet 12.

It can be understood that the interior of the box body 1 can be divided into two cell installation chambers 3 by the separator 2, or divided into three, four, or even more cell installation chambers 3.

It can be understood that, for the convenience of providing a cooling medium circulation device, the liquid inlet 11 and the liquid outlet 12 are both disposed on the first end plate 16. In the present disclosure, the liquid inlet 11 and the liquid outlet 12 are provided on the first end plate 16, combined with the structure of the first flow channel 21 provided within the separator 2, so that the cooling medium has a longer circulation path, being beneficial to improve the balance of temperature difference of each of the cells 51 in the box.

It can be understood that the number of liquid inlet 11 and liquid outlet 12 is not limited herein, as long as each of the cell installation chambers 3 is connected to the liquid outlet 12.

It can be understood that after the cell 51 is installed in the box, the cooling medium is sequentially diverted from the end where the first end plate 16 of the box body 1 is located through the liquid inlet 11 to the other end where the second end plate 17 is located through the first flow channel 21 in the separator 2. During the diverting process, the area inside the box that is difficult to dissipate heat (i.e., the central area of the box body 1) is pre-cooled, and then the second end plate 17 of the box body 1 circulates around the periphery of the cell 51 towards the first end plate 16 with the liquid outlet 12, thereby improving the balance of temperature difference of the areas where multiple cells 51 are located in the box.

The beneficial effects of the embodiments of the present disclosure are as follows: by providing both the liquid inlet 11 and the liquid outlet 12 on the first end plate 16 of the box, the separator 2 inside the box for dividing the interior of the box body 1 into multiple cell installation chambers 3, as well as the first flow channel 21 inside the separator 2, and multiple first outflow outlets 22 at the end of the first flow channel 21 away from the first end plate 16, one of the first outflow outlets 22 is connected to one of the cell installation chambers 3, so that the cooling medium can sequentially flow through the first flow channel 21 inside the separator 2, the second end plate 17 opposite to the first end plate 16 where the liquid inlet 11 is located after being diverted through the liquid inlet 11, as well as flows into the cell installation chambers 3 through the first outflow outlet 22, then gradually flows back to the first end plate 16, and exiting through the liquid outlet 12 located on the first end plate 16, thereby providing a longer circulation path for the cooling medium. The heat of the cell 51 can be dissipated during the process of the cooling medium flowing from the first end plate 16 to the second end plate 17, and the heat of the cell 51 can be dissipates again during the process of the cooling medium flowing from the second end plate 17 to the first end plate 16, being beneficial to improve the effect of cooling. Moreover, the above technical solution allows the cooling medium to pre-cool the area inside the box that is difficult to dissipate heat (i.e. the central area inside the battery pack) as priority, and then cool the remaining areas of the box. As a result, the cooling medium evenly covers every area where each of multiple cells 51 is located, reducing the difference in heat dissipation ability caused by uneven flow of the cooling medium, improving the temperature balance of multiple areas of multiple cells 51 inside the battery pack, and maintaining the stable operation of the cell 51 inside the box.

In some embodiments of the present disclosure, the box body 1 further includes a first side plate 18 and a second side plate 19 arranged opposite to each other. The opposite ends of the first side plate 18 and the second side plate 19 are connected to the first end plate 16 and the second end plate 17, respectively. A plurality of second flow channels 14 are provided on the inner sides of the first side plate 18 and the second side plate 19, and the opposite ends of each of the second flow channels 14 are connected to the first outflow outlet 22 and the liquid outlet 12, respectively.

It can be understood that foam adhesive can be filled between the cell 51 and the first side plate 18 or the second side plate 19 of the box to form each of the second flow channels 14. The structure formed by using foam adhesive can reduce the space between the cell 51 and the first side plate 18 or the second side plate 19, reducing and saving the use amount of cooling medium. To be sure, slots can also be directly machined on the inner sides of the first side plate 18 and the second side plate 19 to form the second flow channels 14.

In some embodiments of the present disclosure, multiple second flow channels 14 are provided in the inner sides the first side plate 18 and the second side plate 19, and the opposite ends of each of the second flow channels 14 are respectively connected to the first outflow outlet 22 and the liquid outlet 12, so that the cooling medium from the first outflow outlet 22 flows back from the second end plate 17 to the first end plate 16 through each of the second flow channels 14, providing a good heat dissipation capability for the side of the cell 51 close to the first side plate 18 and the second side plate 19.

The number of the second flow channels 14 may be multiple, and the extension direction of each of the second flow channels 14 may be parallel to the length direction of the first side plate 18 and the second side plate 19.

It should be noted that in some embodiments of the present disclosure, the flow channel, such as the first flow channel 21, the second flow channel 14, or the third flow channel 15 and the like, can be a linear flow channel, a serpentine flow channel or an irregular flow channel formed by a combination of the linear flow channel and the serpentine flow channel, and the present disclosure is not specifically limited.

In some embodiments of the present disclosure, the box body 1 further includes a bottom plate 20, and the opposite ends of the bottom plate 20 are connected to the first end plate 16 and the second end plate 17, respectively. A plurality of third flow channels 15 are provided on the inner side of the bottom plate 20, and the opposite ends of each of the third flow channels 15 are connected to the first outflow outlet 22 and the liquid outlet 12, respectively.

It can be understood that multiple third channels 15 are disposed on the inner side of the bottom plate 20, achieving the heat dissipation on the bottom of the cell 51 during the cooling medium is flowing in the third channels 15, thereby improving the balance of temperature difference of multiple cells 51 in the battery pack, thus improving the use property and service life of the cells 51.

In some embodiments of the present disclosure, a second outflow outlet 24 is provided in the central area of the first flow channel 21, and the second outflow outlet 24 is connected to each of the third flow channels 15.

It can be understood that due to the fact that parts of the heat dissipation in the side of the cell 51 close to the first side plate 18 and the second side plate 19 can be achieved through air cooling, thus, the heat dissipation capacity of the central and bottom areas in the box is lower compared to that of the areas close to the sides of the box. In an embodiment of the present disclosure, a second outflow outlet 24 is provided in the central area of the first flow channel 21, and the second outflow outlet 24 is connected to the third flow channel 15, thereby obtaining a better heat dissipation ability for the bottom surface of the cell 51, and improving the balance of temperature difference of multiple cells 51.

In some embodiments of the present disclosure, the flow area of the second outflow outlet 24 is less than the flow area of the first outflow outlet 22. Specifically, in the present embodiment, the cross-sections of the second outflow outlet 24 and the first outflow outlet 22 are both circular, that is, the aperture of the second outflow outlet 24 is smaller than that of the first outflow outlet 22.

It can be understood that the flow ratio between the second outflow outlet 24 and the first outflow outlet 22 is specifically provided according to specific heat of the battery, and the flow ratio is not limited herein.

In some embodiments of the present disclosure, the aperture of the second outflow outlet 24 is smaller than that of the first outflow outlet 22, ensuring that the flow rate of the second outflow outlet 24 is less than that of the first outflow outlet 22, thereby diverting most of the cooling medium to the first outflow outlet 22, so as to dissipate heat in the cell 51 close to the second end plate 17, and diverting a small part of the cooling medium to the second outflow outlet 24, so as to dissipate heat on the bottom of the cell 51, as well as preventing most of the cooling medium from flowing back from the central part of the separator 2 to the first end plate 16, thus, being beneficial to improve the balance of temperature difference of multiple cells 51 in the battery pack.

In some embodiments of the present disclosure, a plurality of fourth flow channels 23 are provided on the side wall of the separator 2, and the opposite ends of each of the fourth flow channels 23 are connected to the first outflow outlet 22 and the liquid outlet 12, respectively.

It can be understood that the first flow channel 21 is located inside the separator 2, and the fourth channels 23 are located on the outer side wall of the separator 2, that is, located inside the cell installation chambers 3. The positions of the above-mentioned two channels at the separator 2 are completely different.

It can be understood that the fourth flow channels 23 are provided on both side walls of the separator 2, so as to form a gap between the cell 51 and the separator 2, which not only enables the cooling medium to pre-cool the central area of the box that is difficult to dissipate heat through the first flow channel 21, but also enables the cooling medium to back-flow from the first outflow outlet 22 to the first end plate 16 through the fourth flow channels 23, performing sufficient liquid cooling for the cells 51 located in the central area of the box, thereby achieving secondary cooling of the cells 51 located in the central area of the box, and improving the temperature difference balance of multiple cells 51 in the box.

Similarly, there may be a plurality of fourth flow channels 23, and the extension direction of each of the fourth flow channels 23 may be parallel to the extension direction of the separator 2.

In some embodiments of the present disclosure, the box body 1 further includes a plurality of abutting plates 4 provided on the inner side walls of the first end plate 16 and the second end plate 17, and the abutting plates 4 are disposed between the first end plate 16 and a battery unit 5 of the battery pack, and/or between the second end plate 17 and the battery unit 5 of the battery pack.

In some embodiments of the present disclosure, the abutting plates 4 are provided on the inner side walls of the first end plate 16 and the second end plate 17, so as to block the gap between the cell 51 and the inner wall of the box body 1, playing a role of supporting the cell 51, thereby preventing the displacement of the cell 51 relative to the inner wall of the box body 1 due to the lack of support, and blocking the normal flow of the cooling medium. It can be understood that a transverse flow channel can be provided on each of the abutting plates 4 to communicate the first outflow outlet 22 with the second flow channels 14. A longitudinal flow channel can also be provided to communicate the first outflow outlet 22 with the third flow channels 15. As it should be, the transverse and longitudinal flow channels can also be formed by disposing strip-shaped spacers between the abutting plates 4 and the cell 51 or between the abutting plates 4 and the end plate (first end plate 16 and/or second end plate 17).

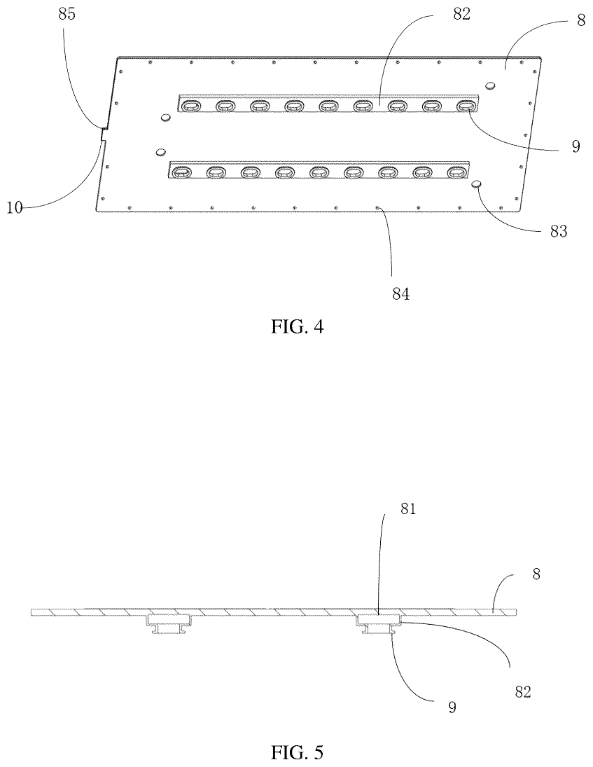

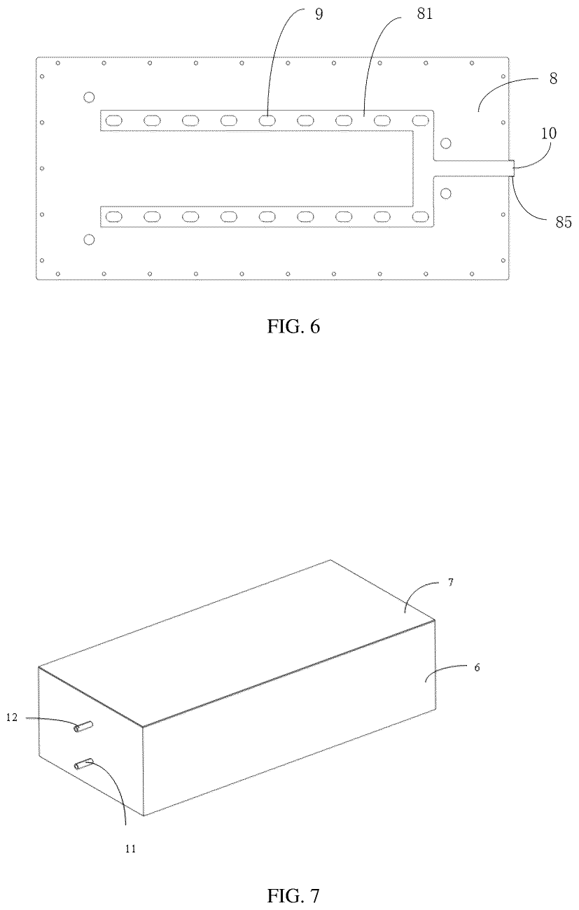

Referring to FIG. 4 to FIG. 6, FIG. 4 is a schematic structural diagram of the box cover 13 in the cell liquid cooling box provided in the present embodiment, FIG. 5 is a schematic cross-sectional diagram of the box cover 13 in the cell liquid cooling box provided in the present embodiment, and FIG. 6 is another schematic cross-sectional diagram of the box cover 13 in the cell liquid cooling box provided in the present embodiment.

In some embodiments of the present disclosure, the box cover 13 includes a cover body 8, a pressure relief valve 9 provided on one side of the cover body 8, a discharge port 10 provided on the end of the cover body 8, and a discharge channel 81 disposed inside the cover body 8. One end of the discharge channel 81 is connected to the pressure relief valve 9, and the other end of the discharge channel 81 is connected to the discharge port 10.

It can be understood that the cover body 8, as a main component of the box cover 13, plays a role in sealing and protecting the box body 1. The cover body 8 has good sealing property to prevent external impurities from entering the box body 1, and also has a certain structural strength to withstand multiple forces from inside and outside the box.

It can be understood that the number of discharge ports 10 and discharge channels 81 can be multiple, and they are not limited herein.

It can be understood that due to chemical reactions or temperature varieties, the cells 51 in the box may bring changes in internal pressure during the operation process. The pressure relief valve 9 are provided on one side of the cover body 8, and the explosion-proof valves 511 on the cells 51 and the pressure relief valve 9 on the cover body 8 will be opened when the internal pressure of the cell 51 exceeds a preset value, releasing some gas and electrolyte, thereby maintaining stable pressure inside the cells 51 and in the box, and preventing the danger caused by excessive internal pressure of the cells 51.

It can be understood that by providing a discharge port 10 at the end of the cover body 8 and a discharge channel 81 inside the cover body 8, one end of the discharge channel 81 connected to the pressure relief valve 9 and the other end connected to the discharge port 10, a pressure relief channel can be provided for the discharge of exhaust gas and electrolyte inside the cells 51. When the exhaust gas and electrolyte are sprayed out from the cells 51, the exhaust gas can be discharged from the discharge channel 81 to the discharge port 10 through the pressure relief valve 9, finally discharged to the external environment, which can effectively prevent the exhaust gas and electrolyte from coming into contact with and mixing with the cooling medium in the box, avoiding the explosion of the battery pack caused by decreasing the insulation of the cooling medium, thereby maintaining the normal operation of the battery pack and extending its service life.

The beneficial effects of the embodiments of the present disclosure are as follows: by providing a pressure relief valve 9 on the side of the cover body 8 and a discharge channel 81 for discharging exhaust gas and electrolyte from the battery pack safely inside the cover body 8, so that the exhaust gas and electrolyte discharged from the explosion-proof valve 511 in the battery pack can be discharged through the pressure relief valve 9, the discharge channel 81, and the discharge port 10 on the cover body 8, which can effectively prevent the electrolyte and exhaust gas sprayed out by the cell 51 immersed in the cooling medium from coming into contact with the cooling medium during operation, avoiding the explosion of the battery pack caused by decreasing the insulation of the cooling medium, thereby improving the safety of the battery pack in use, and providing strong guarantee for the long-term stable operation of the battery pack.

In some embodiments of the present disclosure, the cover body 8 includes a main body and a protruding portion 82 protruding from the main body, the pressure relief valve 9 is located on the surface of the protruding portion 82 away from the main body, the discharge channel 81 extends to the protruding portion 82, which penetrates through the protruding portion 82 along the protruding direction of the protruding portion 82 and is connected to the pressure relief valve 9. The discharge channel 81 within the protruding portion 82 forms a first channel.

The protruding portion 82 is disposed on one side of the main body of the cover body 8, the pressure relief valve 9 is located on the surface of the protruding portion 82 away from the main body, the discharge channel 81 extends to the protruding portion 82, which penetrates through the protruding portion 82 and is connected to the pressure relief valve 9, thereby forming the first channel, which can provide a buffer space for releasing the internal pressure of the cells 51 when the cells 51 explodes at the explosion-proof valve 511, reducing the degree of deformation of the cover body 8 due to the impact of high-pressure, thereby reducing the possibility of the cover body 8 being broken due to the impact.

In some embodiments of the present disclosure, a second channel is formed in the pressure relief valve 9, and the volume of the second channel is smaller than that of the first channel.

The second channel is formed in the pressure relief valve 9, and the volume of the second channel is smaller than that of the first channel, so that the exhaust gas and electrolyte entering from the pressure relief valve 9 can be properly buffered through the first channel in the cover body 8, reducing the degree of deformation of the cover body 8 due to high-pressure impact, thereby reducing the possibility of the cover body 8 being broken due to impact.

In some embodiments of the present disclosure, the first channel and the second channel are both cylindrical, and the inner diameter of the second channel is smaller than that of the first channel.

It can be understood that the ratio of the internal volumes of the first channel and the second channel can be determined by providing the ratio of the inner diameters of the first channel and the second channel, or by providing the ratio of the heights of the first channel and the second channel, thereby achieving that the volume of the first channel is larger than that in the second channel, so that the exhaust gas and electrolyte entering from the pressure relief valve 9 can be properly buffered through the first channel in the cover body 8, thereby reducing the degree of deformation of the cover body 8 due to high-pressure impact, thereby reducing the possibility of the cover body 8 being broken due to impact.

In some embodiments of the present disclosure, the pressure relief valve 9 is provided with an elastic seal around the valve port, and the elastic seal is configured to abut against the outer periphery of the valve port of the explosion-proof valve 511 of the cell 51.

It can be understood that the shape of the elastic seal includes but is not limited to a solid ring, a hollow ring, a ring with a rectangular cross-section, a ring with a circular cross-section, etc., and the material of the elastic seal includes but is not limited to rubber, silicone, etc.

It can be understood that the elastic seal, as an elastic material, can fit the outer periphery of the explosion-proof valve 511 on the cell 51 closely, thereby preventing gas or liquid from leaking from the gap effectively, can improve the connection between the box cover 13 and the cell 51 significantly, avoiding gas leakage or electrolyte spillage during working.

It can be understood that the elastic seal has a certain elasticity and buffering effect. When the box cover 13 contacts the valve port of the pressure relief valve 9 on the cell 51, the elastic seal can absorb part of the impact force and reduce the wear or damage caused by hard contact. This helps to extend the service life of the box cover 13 and the cell 51, and also ensures the stability of the battery system.

It can be understood that the softness and elasticity of the elastic seal make it easier for the box cover 13 to be aligned and separated from the valve port of the explosively opening valve on the cell 51 during assembly and disassembly, which can reduce the difficulty of operation, improve the efficiency of disassembly/assembly, and reduce the risk of damage caused by improper operation.

It can be understood that the elastic seal has a certain adaptability to changes of the temperature and pressure, can maintain stable sealing performance under different temperature environments, which enables the box cover 13 to maintain reliable performance in a complex and changeable working environment.

In summary, it can not only improve the sealing performance and prevent gas and liquid from leaking, but also play a buffering and protective role, improve the convenience of assembly and disassembly. This design helps to ensure the safety and stability of the battery system and improve the overall performance.

In some embodiments of the present disclosure, a hole portion is provided on the cover body 8, wherein the hole portion includes the mounting hole 83 configured for fixing bolts on the internal bus of the battery pack to pass through.

It can be understood that the cover body 8 can be made of a conductive material or an insulating material.

It can be understood that the mounting hole 83 can be a through hole or a blind hole.

It can be understood that the diameter of the fixing bolt is smaller than the diameter of the mounting hole 83, so that the outer wall of the fixing bolt is separated from the inner wall of the mounting hole 83. It can be understood that the top surface of the nut of the fixing bolt also needs to be separated from the bottom surface of the cover body 8.

The embodiment of the present disclosure sets a mounting hole 83 on the cover body 8, and sets the diameter of the fixing bolt smaller than the inner diameter of the mounting hole 83, so that when the cover body 8 is made of conductive material, the inner wall of the mounting hole 83 and the outer wall of the fixing bolt on the bus inside the battery pack are separated by a safe electrical distance, avoiding conductivity between the bus and the cover body 8 and improving the safe conductivity of the bus.

In some embodiments of the present disclosure, the hole portion further includes a threaded hole 84 on the edge of the cover body 8, and the threaded hole 84 is configured to cooperate with a screw to realize fixed connection between the cover body 8 and the box body 1.

In the embodiment of the present disclosure, threaded holes 84 are provided on the cover body 8, so that the cover body 8 can be fixedly connected to the box body 1 by bolts after being installed, combining the pressure relief valve 9 on the cover body 8 with the explosion-proof valve 511 on the cell 51 tightly.

In some embodiments of the present disclosure, an extending portion 85 is provided at the end of the cover body 8, and the discharge channel 81 extends to and penetrates through the extending portion 85.

It should be noted that the number of the extending portions 85 includes but is not limited to one.

In the embodiment of the present disclosure, an extension portion 85 is provided at the end of the box cover 13, and the discharge channel 81 extends to and penetrates through the extending portion 85, so that the exhaust gas and/or electrolyte in the discharge channel 81 can be discharged out of the battery pack through the extending portion 85.

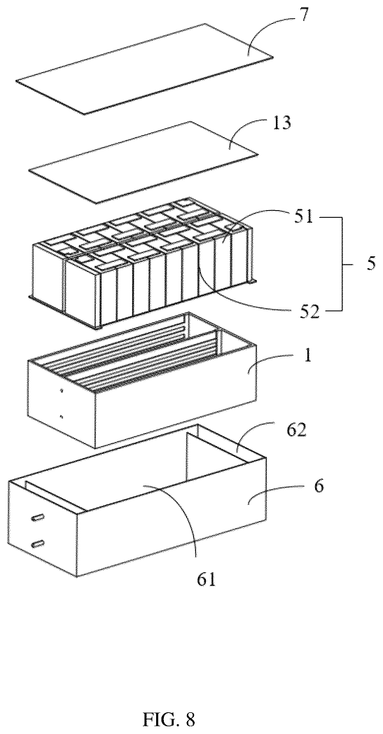

Based on the same concept, referring to FIG. 7 to 8, FIG. 7 is a structural diagram of the battery pack provided by the embodiment of the present disclosure, and FIG. 8 is an explosion diagram of the battery pack provided by the embodiment of the present disclosure. The present disclosure also provides a battery pack, including the above-mentioned cell liquid cooling box and multiple battery units 5, and the multiple battery units 5 are installed in the cell installation chamber 3.

It can be understood that since the cell liquid cooling box in the embodiment of the present disclosure has the effect of improving the poor temperature difference balance of the cells 51 in the box, so the battery pack provided in the embodiment of the present disclosure also has this effect, which will not describe redundantly here.

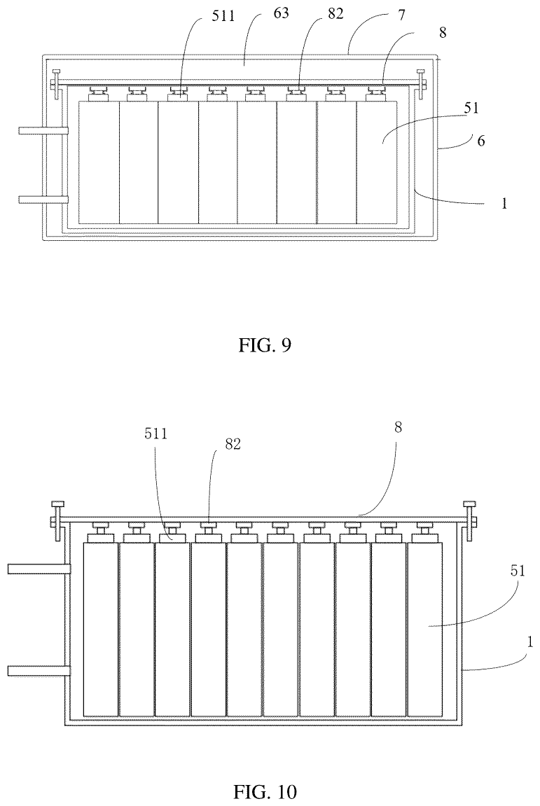

In some embodiments of the present disclosure, referring to FIG. 8 to 9, FIG. 9 is a cross-sectional diagram of the battery pack provided by the embodiment of the present disclosure, the battery pack further includes a mounting case 6 and a case cover 7, the mounting case 6 includes:
A first accommodating chamber 61, the box body is located in the first accommodating chamber 61, and/or;
A second accommodating chamber 62, the second accommodating chamber 62 is configured to accommodate a battery management system module, and/or;
A third accommodating chamber 63 is formed between the top of the box body and the case cover 7, which is configured to accommodate the CCS (Cells Contact System) component.

It can be understood that based on the need for easy product molding and improved assembly efficiency, the battery pack can also include the installation of the mounting case 6 and the case cover 7, the separator 2 located in the box body, and the outer wall of the box body fits with the inner wall of the installation mounting case 6, so as to facilitate the manufacture and assembly of the box body and the installation of mounting case 6.

It can be understood that the installation of mounting case 6 includes the first accommodating chamber 61 configured to accommodate the box body, a second accommodating chamber 62 configured to accommodate the battery management system module, and the third accommodating chamber 63 formed between the top of the box body and the case cover 7, so that the battery management system module and the CCS component are respectively separated from the cooling medium in the cell installation chamber 3, ensuring the stable running of the CCS component and the battery management system module.

In some embodiments of the present disclosure, the battery unit 5 includes a plurality of cells 51, which are arranged in sequence at intervals, and a fifth flow channel 52 is defined between the cells 51.

It can be understood that spacers can be provided between the cells 51 to form a fifth flow channel 52, and the fifth flow channel 52 is located between adjacent cells 51 which is in the cell installation chamber 3.

In the embodiment of the present disclosure, the fifth flow channel 52 is provided between the cells 51 so that the cooling medium fully surrounds the circumference of each cell 51 to achieve temperature difference balance for each cell 51 in the battery pack and reduce the thermal coupling effect between the cells 51.

There may be a plurality of fifth flow channels 52, and the extension direction of the fifth flow channel 52 can be parallel to the extension direction of the length direction of the cell 51.

Referring to FIG. 10, FIG. 10 is another cross-sectional diagram of the battery pack provided in an embodiment of the present disclosure. The embodiment of the present disclosure further includes a battery pack including the cell liquid cooling box and the cell 51 as described above, the cell 51 is mounted in the cell immersion cavity, the box cover 13 is covered on the box body 1, the pressure relief valve 9 is disposed on the box cover 13 opposite to the explosion-proof valve 511 of the cell 51, the box cover 13 is covered on the cell immersion cavity, and fixedly connected to the box body 1, the pressure relief valve 9 of the box cover 13 and the explosion-proof valve 511 of the cell 51 are in low interference fit.

In the embodiment of the present disclosure, the cell 51 is placed in the box body 1, the box cover 13 is covered and being fixed connection to the box body 1, the pressure relief valve 9 on the box cover 13 is directly opposite to the explosion-proof valve 511 of the cell 51 and is in low interference fit with the explosion-proof valve 511, so that the exhaust gas and electrolyte can pass through the explosion-proof valve 511 of the cell 51 smoothly, and be discharged from the cell immersion cavity through the pressure relief valve 9 and the discharge channel 81 in the box cover 13, avoiding the electrolyte and exhaust gas in the cell 51 from contacting with the cooling medium and causing pollution to the cooling medium, thereby preventing the stable running of the battery pack from being affected by the low insulation of the cooling medium.

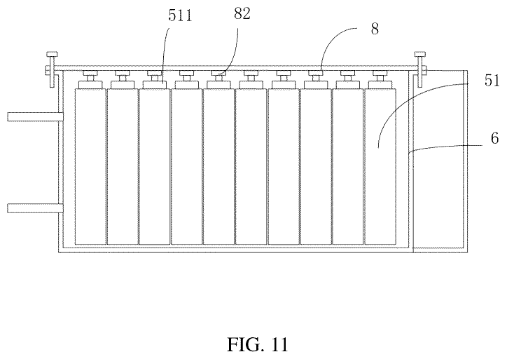

Based on the same concept, referring to FIG. 11, FIG. 11 is another cross-sectional diagram of the battery pack provided in the embodiment of the present disclosure. The embodiment of the present disclosure further includes a battery pack including the above-mentioned cell liquid cooling box, the above-mentioned mounting case 6 and the cell 51. The cell liquid cooling box is integrated with the mounting case 6. Specifically, the cell immersion cavity is formed in the mounting case 6, the cell 51 is installed in the cell immersion cavity, the box cover 13 covers on the cell immersion cavity, the pressure relief valve 9 on the box cover 13 is directly opposite to the explosion-proof valve 511 of the cell 51, the box cover 13 covers on the cell immersion cavity and is fixed to the mounting case 6, the pressure relief valve 9 of the box cover 13 is in low interference fit with the explosion-proof valve 511 of the cell 51.

It can be understood that the flow channel or liquid cooling plate on the box body in FIG. 8 can be directly integrated into the interior of the mounting case 6, the CCS component connected to the bus on the cell 51 can be arranged above the box cover 13 which is fixedly connected to the mounting case 6, a plurality of side panels and the bottom plate 20 can be arranged on the outside of the mounting case 6 to form a top-opening placement cavity, and the placement cavity can be configured to place a battery system management module connected to the CCS component.

In an embodiment of the present disclosure, the cell 51 is placed in the cell immersion cavity of the mounting case 6, the pressure relief valve 9 on the box cover 13 is directly opposite to the explosion-proof valve 511 of the cell 51 and covers on the cell immersion chamber, and is fixed to the mounting case 6, so that the pressure relief valve 9 of the box cover 13 and the explosion-proof valve 511 of the cell 51 are in low interference fit. Therefore, the exhaust gas and electrolyte sprayed from the cell 51 can pass through the explosion-proof valve 511 of the cell 51 smoothly, and be discharged from the cell immersion cavity through the pressure relief valve 9 and the discharge channel 81 in the box cover 13, preventing the electrolyte and exhaust gas in the cell 51 from contacting with the cooling medium and causing pollution to the cooling medium, thereby preventing the stable running of the battery pack from being affected by the low insulation of the cooling medium.

What is claimed is:

1. A box, comprising:
a box body, comprising a first end plate and a second end plate arranged opposite to each other, wherein the first end plate is provided with a liquid inlet and a liquid outlet; and
a separator disposed in the box body; wherein both ends of the separator are connected to the first end plate and the second end plate, respectively; interior of the box body is divided into a plurality of cell installation chambers, a first flow channel is provided within the separator, one end of the first flow channel is connected to the liquid inlet, and another end of the first flow channel extends to the second end plate and is provided with a plurality of first outflow outlets, the first outflow outlets are connected to and communicated with the cell installation chambers, and each of the cell installation chambers is connected to and communicated with the liquid outlet.

2. The box according to claim 1, wherein the box body further comprises a first side plate and a second side plate arranged opposite to each other, opposite two ends of the first side plate and the second side plate are respectively connected to the first end plate and the second end plate; a plurality of second flow channels are provided on inner sides of the first side plate and the second side plate, and opposite ends of each of the second flow channels are connected to and communicated with one of the first outflow outlets and the liquid outlet, respectively.

3. The box according to claim 1, wherein the box body further comprises a bottom plate, opposite ends of the bottom plate are respectively connected to the first end plate and the second end plate; a plurality of third flow channels are provided on an inner side of the bottom plate, and both ends of each of the third flow channels are connected to and communicated with one of the first outflow outlets and the liquid outlet, respectively.

4. The box according to claim 3, wherein a second outflow outlet is provided in a central area of each of the first flow channels, and the second outflow outlet is connected to and communicated with one of the third flow channels.

5. The box according to claim 4, wherein a flow area of the second outflow outlet is less than a flow area of one of the first outflow outlets.

6. The box according to claim 1, wherein a plurality of fourth flow channels are provided on side walls of the separator, and opposite ends of each of the fourth flow channels are connected to and communicated with one of the first outflow outlets and the liquid outlet respectively.

7. The box according to claim 1, wherein the box body further comprises a plurality of abutting plates disposed on inner sides of the first end plate and the second end plate, the abutting plates are disposed
between the first end plate and a battery unit of a battery pack; and/or
between the second end plate and the battery unit of the battery pack.

8. A cell liquid cooling box, comprising a box and a box cover, wherein the box is covered by the box cover;
the box comprises:
a box body, comprising a first end plate and a second end plate arranged opposite to each other; wherein a liquid inlet and a liquid outlet are provided on the first end plate; and
a separator disposed in the box body; wherein both ends of the separator are connected to the first end plate and the second end plate, respectively; the interior of the box body is divided into a plurality of cell installation chambers; a first flow channel is provided within the separator, one end of the first flow channel is connected to the liquid inlet, and the other end of the first flow channel extends to the second end plate and is provided with a plurality of first outflow outlets, the first outflow outlets are connected to the cell installation chambers, and each of the cell installation chambers is connected to the liquid outlet.

9. The cell liquid cooling box according to claim 8, wherein the box cover further comprises a cover body; pressure relief valves are provided on one side of the cover body; a discharge port is provided at an end of the cover body; and at least one discharge channel is provided within the cover body, and one end of the discharge channel is connected to each of the pressure relief valves and another end of the discharge channel is connected to and communicated with the discharge port.

10. The cell liquid cooling box according to claim 9, wherein the cover body comprises a main body and at least one protruding portion protruding from the main body, the pressure relief valve is positioned on a surface of the protruding portion away from the main body, the discharge channel extends into the protruding portion and is connected to and communicated with the pressure relief valve, and the discharge channel within the protruding portion forms a first chamber.

11. The cell liquid cooling box according to claim 9, wherein a second chamber is provided within the pressure relief valve, and a volume of the second chamber is smaller than a volume of the first chamber.

12. The cell liquid cooling box according to claim 10, wherein the first chamber and the second chamber are both cylindrical in shape, and an inner diameter of the second chamber is smaller than an inner diameter of the first chamber.

13. The cell liquid cooling box according to claim 8, wherein the pressure relief valve is provided with an elastic seal around a valve port, and the elastic seal is configured to abut against an outer periphery of the valve port of an explosion-proof valve (511) for each of cells.

14. The cell liquid cooling box according to claim 8, wherein a hole portion is provided on the cover body.

15. The cell liquid cooling box according to claim 8, wherein the end of the cover body is provided with an extending portion, and the discharge channel extends to and penetrates through the extending portion.

16. A battery pack, comprising a cell liquid cooling box and a plurality of battery units, wherein the battery units are installed inside cell installation chambers;
wherein the cell liquid cooling box comprises:
a box and a box cover, wherein the box cover is covered on the box;
the box, comprising:
a box body, comprising a first end plate and a second end plate arranged opposite to each other; wherein a liquid inlet and a liquid outlet are provided on the first end plate; and
a separator disposed in the box body; wherein both ends of the separator are connected to the first end plate and the second end plate, respectively; the interior of the box body is divided into a plurality of cell installation chambers; a first flow channel is provided within the separator, one end of the first flow channel is connected to the liquid inlet, and the other end of the first flow channel extends to the second end plate and is provided with a plurality of first outflow outlets, the first outflow outlets are connected to the cell installation chambers, and each of the cell installation chambers is connected to the liquid outlet.

17. The battery pack according to claim 16, wherein each of the battery units comprises a plurality of cells, the cells are arranged sequentially at intervals, and a fifth flow is provided between adjacent two ones of the cells.

18. The battery pack according to claim 16, wherein the battery pack further comprises a mounting case and a case cover, the mounting case comprises:
a first accommodating chamber, wherein the box is located in the first accommodating chamber, and/or
a second accommodating chamber, configured to accommodate a battery management system module, and/or
a third accommodating chamber, formed between a top of the box and the case cover, and configured to accommodate a CCS assembly.

19. The battery pack according to claim 16, wherein a cell immersion chamber is formed inside the box body, the box cover is covered on the cell immersion chamber and is fixedly connected to the box body.

20. The battery pack according to claim 18, wherein a cell immersion chamber is provided within the mounting case, the cells are installed inside the cell immersion chamber, the box cover is covered on the cell immersion chamber and is fixedly connected to the mounting case; and
the pressure relief valve on the box cover is directly opposite to each of explosion-proof valves of the cells, and the pressure relief valve on the box cover abuts against each of the explosion-proof valves of the cells with an interference fit.
